(19) United States
(12) Patent Application Publication
(10) Pub. No.: US 2005/0250361 A1
(43) Pub. Date: Nov. 10, 2005

(54) Secure cap of a plug

(76) Inventor: Chun-Chang Yen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/838,264

(22) Filed: May 5, 2004

(51) Int. Cl. H01R 13/44

(52) U.S. Cl. 439/140

(57) ABSTRACT

The invention relates to a secure cap of a plug, which includes a plug having inner fuses and a moveable cap. The cap is provided with an under convex edge near to the end. Hence, the cap can be bent, as bearing a downward force before the projections of the plug is broken for preventing the cap from being released or separated.

### FIELD OF THE INVENTION

The present invention relates to an improvement of a plug, which has a secure cap being capable of preventing from releasing and lost.

### BACKGROUND OF THE INVENTION

As shown in FIG. 1 to 4, a conventional plug (1) is provided with a pair of inward projections (11) for engaging with the end of a fuse cap (2). At the opening place of the cap (2), the fuse can be provided or replaced. In this state, even a little downward force presses the opening cap (2), as direction of arrow in FIG. 1, the projections (11) will be easily broken (as in FIG. 4). Hence, the cap (2) is going to be released from the plug (1) and can't be used in secure.

### SUMMARY OF THE INVENTION

The present invention is to provide a secure cap of a plug, which can overcome the drawback of the prior art that the cap will be engaged with the plug firmly and the projections of the plug will not be broken. Now, accompanying with the following drawings, the character of the present invention will be described here and after.

### BRIEF DESCRIPTION OF THE DRAWINGS

FIG. 1 is a partly cross-sectional plan view showing a conventional plug with fuse and cap.

FIG. 2 is a left side view of FIG. 1.

FIG. 3 is a plan view of FIG. 2 showing the cap is released from the plug.

FIG. 4 is a left side view showing the plug of FIG. 3.

FIG. 5 is a perspective view showing a plug with fuse and cap according to the present invention.

FIG. 6 is a perspective view of FIG. 6 showing the cap is pulled out.

FIG. 7 is an exploded perspective view of FIG. 5.

FIG. 8 is a partly cross-sectional plan view showing the assembled plug according to the present invention.

FIG. 9 is a plan view of FIG. 8 showing the cap is pressed downward.

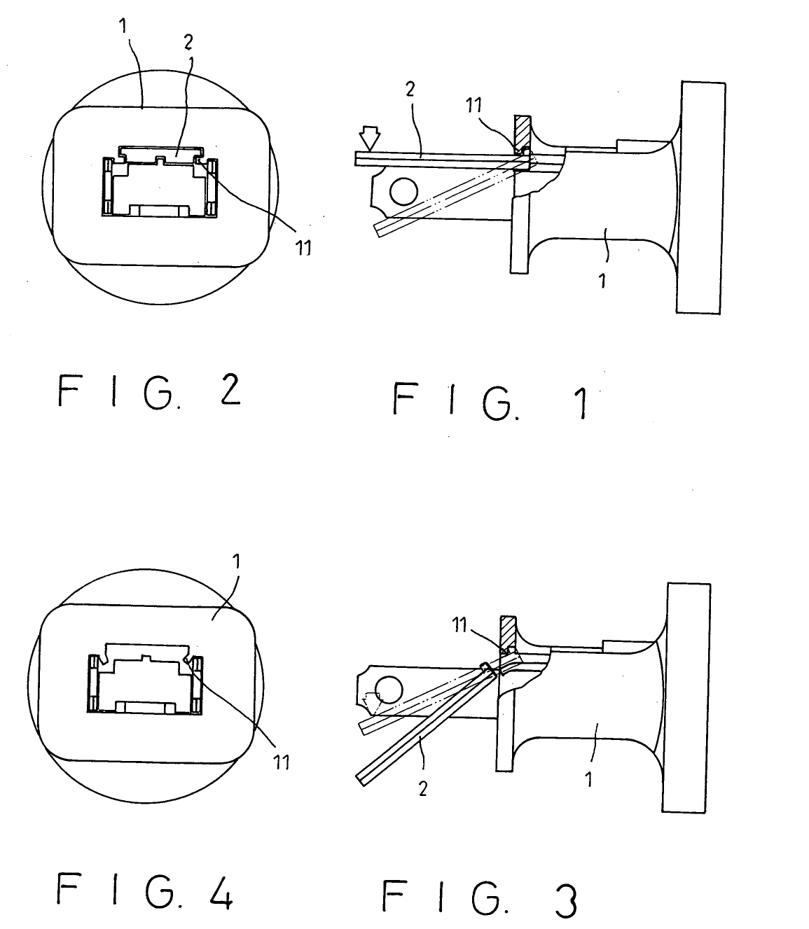

### DETAILED DESCRIPTION OF THE PREFERRED EMBODIMENT

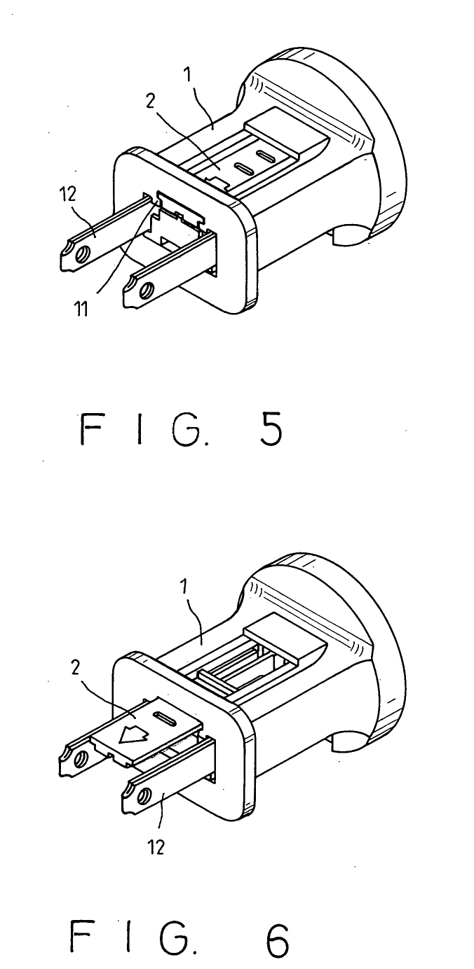

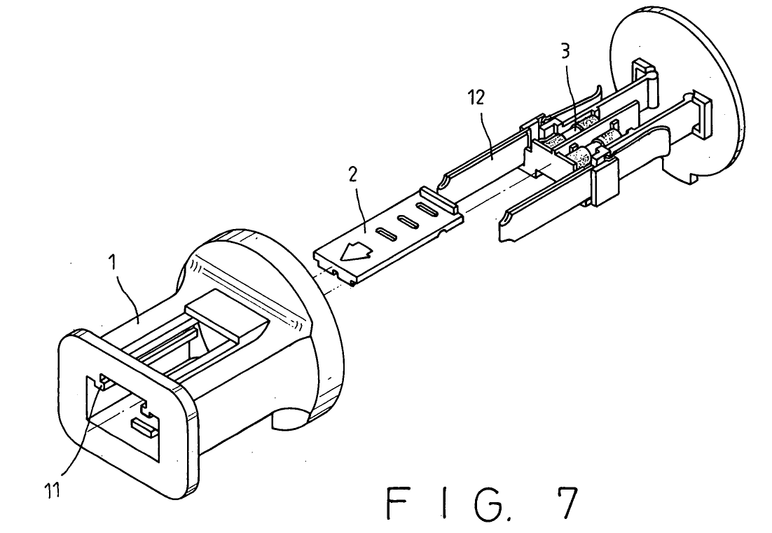

Please referring to FIG. 5 to 7, the present invention includes a plug (1) with inner fuses (3) connecting with two metal slices (12). A moveable fuse cap (2) is provided on the plug (1) covering the fuses (3). A pair of inward projections (11) is provided at side of the plug (1) to engage with the end of the cap (2) for preventing the cap from being released.

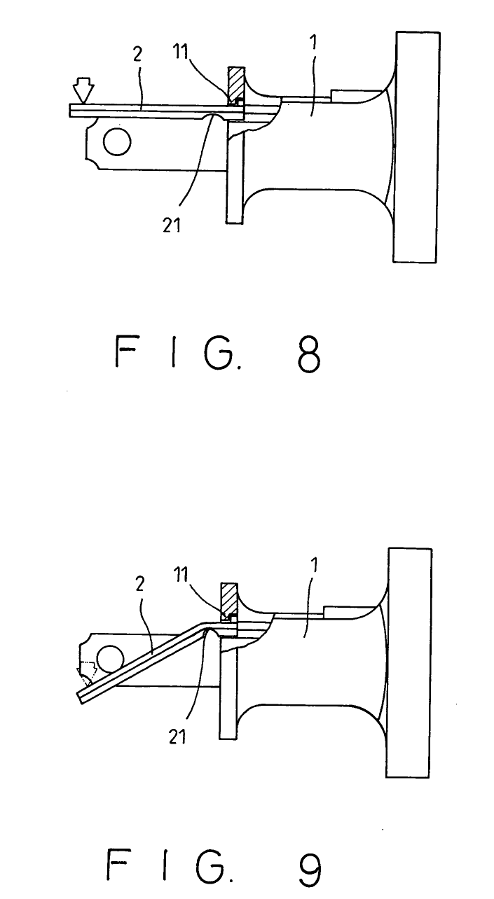

The improvement of the present invention is to provide a convex edge (21) under the cap (2), which is near to the end. As shown in FIG. 8 and 9, when the cap (2) is pressed by a downward or upward force, the cap (2) will be bent before the projections (11) are broken. Hence, the cap is still engaged with the plug (1) instead of being separated that overcomes the drawback of prior art.

Since the cap (2) is made of plastic, it can be recovered as a plate form to be pushed back for covering the fuses (3) for normal use.

Accordingly, the present invention overcomes the drawback of prior structure. It is obviously utilized and effective that should be allowed for patent.

1. A secure cap of a plug including a plug having inner fuses and a moveable cap, and the improvement is in that the cap is provided with an under convex edge, which is near to the end that provides the cap can be bent as bearing a downward force.
